(19) United States
(12) Patent Application Publication
(10) Pub. No.: US 2023/0136635 A1
(43) Pub. Date: May 4, 2023

(54) SELECTIVE FORMATION AND MAINTENANCE OF TUNNELS WITHIN A MESH TOPOLOGY

(71) Applicant: HEWLETT PACKARD ENTERPRISE DEVELOPMENT LP, Houston, TX (US)

(72) Inventors: Abhinesh Mishra, Bangalore (IN); Isaac Theogaraj, Bangalore (IN); Prakash Chand Sharma, Santa Clara, CA (US)

(21) Appl. No.: 17/515,125

(22) Filed: Oct. 29, 2021

(51) Int. Cl. H04L 12/24; H04L 12/28

(52) U.S. Cl. CPC H04L 41/0893; H04L 12/2854

(57) ABSTRACT

Systems and methods are provided for clustering network devices into cohorts. Next, the systems may determine a subset of the network devices between which tunnels are created, based on any of amounts of available memory, jitter, latency, packet loss, and average round trip time. The selective determination may include, determining to create a first tunnel between a first network device of the first cohort and a second network device within the first cohort, and a second tunnel between the first network device and a third network device within the second cohort, and determining not to create tunnels between first remaining network devices of the first cohort and the second set of network devices of the second cohort. The systems provision the tunnel and the second tunnel to transmit data.

### BACKGROUND

Within networks such as Wide Area Networks (WANs), tunneling is a mechanism that creates a connection between two locations of a data network while maintaining data security and bandwidth separation. Some existing solutions may implement a full mesh topology which includes tunnels between every single device.

### BRIEF DESCRIPTION OF THE DRAWINGS

The present disclosure, in accordance with one or more various examples, is described in detail with reference to the following figures. The figures are provided for purposes of illustration only and merely depict typical or example examples.

FIG. 1A is an exemplary illustration of a computing system that that regulates, coordinates, or controls functions of a network such as a WAN or a SDWAN, according to examples described in the present disclosure.

FIG. 1B is an exemplary illustration that elucidates further contextual details of the network as illustrated in FIG. 1A, according to examples described in the present disclosure. FIGS. 1A and 1B may be applicable to subsequent figures, including FIGS. 2, 3A-3D, 4A-4D, and 5-6.

FIG. 2 is an exemplary illustration of a computing component that determines a number of cohorts to divide the network devices of the network illustrated in FIGS. 1A and 1B, and assigning particular network devices to particular cohorts, while connecting network devices in a common cohort according to a full mesh topology, according to examples described in the present disclosure.

FIG. 3A is an exemplary illustration of a computing component that determines, appoints, or assigns a single leader in each of the cohorts, while connecting the leaders in each of the cohorts according to a full mesh topology, according to examples described in the present disclosure. The implementation illustrated in FIG. 3A may be combined with that illustrated in FIG. 2, according to examples described in the present disclosure.

FIG. 3B is an exemplary illustration of how the implementations in FIG. 3A and FIG. 2 may be combined, according to examples described in the present disclosure.

FIGS. 3C and 3D are exemplary illustrations of connections between cohorts and a node such as a data center, according to examples described in the present disclosure. In FIG. 3C, the network devices assigned as leaders are connected to the data center. In FIG. 3D, all devices within a cohort are connected to the data center. The data center may provide an alternate data transmission pathway, as illustrated in FIGS. 4A-4D.

FIGS. 4A-4D may be implemented in conjunction with any of the principles described with regard to FIGS. 1A, 1B, 2, and 3A-3D, according to examples described in the present disclosure. FIGS. 4A-4D elucidate a scenario in which a network device or a tunnel becomes inoperational and a computing component updates routes of data transmission to avoid the inoperational network device or the inoperational tunnel.

FIG. 4A is an exemplary illustration of a computing system that regulates, coordinates, or controls functions of a network such as a WAN or a SDWAN, different from FIGS. 1A and 1B, but following the same principles as described with reference to previous FIGS. 1A, 1B, 2, and 3A-3D, according to examples described in the present disclosure.

FIGS. 4B-4C illustrate a scenario in which one of the network devices has become inoperational, according to examples described in the present disclosure. FIG. 4B illustrates a status prior to tunnel removal. FIG. 4C illustrates that tunnels connecting to the inoperational device may be removed.

FIG. 4D illustrates a scenario in which one of the tunnels has become inoperational, according to examples described in the present disclosure.

FIG. 5 is an exemplary flowchart, illustrating how a computing component reduces computing costs while maintaining network services and performance, according to examples described in the present disclosure.

FIG. 6 is an exemplary flowchart, further elaborating on some steps described with respect to FIG. 5.

FIG. 7 is an example computing component that may be used to implement various features of examples described in the present disclosure.

The figures are not exhaustive and do not limit the present disclosure to the precise form disclosed.

### DETAILED DESCRIPTION

Traditionally, wide area networks (WANs) have bridged gaps between local area networks (LANs), which may reside in different geographical locations. WANs rely on hardware network devices such as gateways or routers to prioritize transmission of data, voice, and video traffic between LANs. The increase of cloud service providers and Software as a Service (SaaS) has triggered a concurrent rise in data being stored on over cloud networks. To more effectively adapt to the rapidly growing usage of cloud networks, software-developed WANs (SDWANs) have developed as a new paradigm. SDWANs provide centralized and/or software-based controls of policies that coordinate traffic paths, failover, and real-time monitoring to reduce delays in data transmission, thereby automating functions that were previously manually configured. Nodes, sites, portions, or branches of a WAN in the SDWAN may be connected via multiprotocol label switching (MPLS), Last Mile Fiber Optic Network, wireless, broadband, virtual private networks (VPNs), Long Term Evolution (LTE), 5G, 6G, and the internet. SDWANs may also implement virtual tunnels which constitute a logical overlay over an existing physical network of WANs. These tunnels may include any of Internet Protocol Security (IPSec), User Datagram Protocol (UDP), Transmission Control Protocol (TCP), Generic Routing Encapsulation (GRE), Virtual Extensible LAN (VxLAN), Datagram Transport Layer Security (DTLS), grpc Remote Procedure Call (gPRC) or some other IP-based protocol tunnel. These tunnels may be instrumental in establishing connections to data and services stored at different portions of the SDWANs, for example, among branches or sites, thus providing additional and more efficient access to data and services while maintaining data security. Tunnels may bridge portions of the SDWANs which have disjoined capabilities, policies, and protocols via the shipping of protocols that are otherwise unsupported by the portions of the SDWANs. As an example, IPSec tunnels protect data traffic by ensuring confidentiality, integrity, authentication, and anti-replay. Confidentiality encompasses encryption of data so that only a sender and receiver would be able to read data packets. Integrity entails transmitting both the sender and the receiver a hash valve so that both parties will become aware of any changes to the data packets. Meanwhile, authentication provides the sender and the receiver assurance regarding identities of each other. Lastly, anti-replay prevents transmission of duplicate packets by a potential attacker. In some examples, IPSec tunnels may be implemented in conjunction with Dynamic Multipoint VPN (DMVPN), MPLS-based L3 VPN, and layer 2 (L2) tunneling protocols.

One type of topology in SDWANs includes a hub-and-spoke topology, in which different portions, branches, or sites (hereinafter “branches”) of a SDWAN are connected to other branches via a data center or a centralized center (hereinafter “data center”). In such a hub-and-spoke topology, the branches of a SDWAN are not directly connected to one another via tunnels. However, a full mesh topology has been more frequently implemented. In such a full mesh topology, each branch is connected to all other branches, along with a data center, via tunnels. The tunnels may be bidirectional. Tunneling results in a number of benefits, such as, faster transmission as a result of direct connections among branches rather than indirect connections that traverse the data center. Other benefits include more efficient and secure data transmission, and increasing redundancy of paths to transmit data. However, an excessive amount of tunneling, such as in a full-mesh topology, may constitute a double-edged sword.

One downside of direct tunnels among branches is the resulting additional consumption of computing resources, as manifested, for example, by additional bytes to existing IP packets and increased bandwidth. The additional bytes may have a detrimental impact on transmission and queueing delay, thereby affecting jitter and overall packet delay. The added packet size may also result in fragmentation of packets due to the packets exceeding a threshold size. Fragmentation may increase chances of packet drop and increase consumption of processing power, memory, and CPU. In some applications such as Voice over Internet Protocol (VoIP), overhead resulting from tunnels may consume as much as 40% to 100% additional packet bandwidth, resulting in compromised bandwidth efficiency, increased latency, and packet drop.

Furthermore, the requirement of hardware such as routers, which support tunnels, increases a load on processors of the hardware. This load is exacerbated as a number of sites or branches of a network increases. The support of tunnels entails transmitting, from the routers, for example, periodic probe traffic, or probe packets, to maintain liveliness of each of the tunnels. Once the router transmits the probe packets, the router may determine whether any response to the probe packets has been received from respective endpoints (e.g., other network devices such as routers) of the tunnels. If the router detects a response to a probe packet, and that the response further indicates an identifier, such as an Internet Protocol (IP) address, of the router, then the router determines that the response was successful. Thus, the tunnel through which the probe packet was transmitted is maintained. However, if the router fails to detect a response to the probe packet, then the router may resend the probe packet a threshold number of times at threshold intervals, such as, four retries every five seconds. If still no response, or an improper response (e.g., failing to indicate an identifier of the router), then the router determines that the response is unsuccessful. In such a situation, the tunnel may be removed. Bandwidth consumed in such a process may be computed as a product of a number of tunnels, a probe packet size, and a probe burst size indicating a number of probe packets transmitted simultaneously, divided by a time interval of the transmission of the probe packets. The probe packets may be UDP based packets of around 200 bytes. The probe packets may be transmitted regardless of whether, or how much, data is being transmitted across the tunnels. In other words, even a tunnel being utilized does not exempt the router, or other computing component, from transmitting probe packets in order to maintain that tunnel. A full mesh network entails each branch gateway or router at each site forming tunnels with all the other branch gateways or routers at different sites, resulting in n*(n−1)/2 total tunnels, wherein n indicates a number of network devices. Within a branch topology having only 16 network devices, such as routers or gateways, with each network device having three uplinks, in some implementations, an estimated 9.3 Gigabytes (GB) of traffic may be, for example, consumed to merely maintain the liveliness of the tunnels over a 24-hour duration within a full mesh network. In some examples, uplinks may indicate a number of separate WAN connections or links between two branches. Additionally, a cloud service, or microservice such as an orchestrator, which controls and coordinates operations on the network, computes cryptographic maps for each of the tunnels, and propagates these cryptographic maps via a tunnel such as a Remote Procedure Call (RPC) tunnel to each of devices that are associated with each of the branches. The additional computing resources incurred as a result of a full mesh network may be prohibitive and severely hamper performance within the network, especially as a number of devices continues to proliferate.

Examples described herein address these challenges by implementing a computing component, such as a server, that selectively establishes tunnels among certain network devices that constitute a network, such as a WAN or SDWAN, environment. This selective establishment entails determining a number of the tunnels to be formed, as well as which network devices tunnels are to be formed between. As alluded to previously, a number of tunnels formed is less than that of a full mesh topology, in order to reduce a cost of computing resources. Therefore, some pairs of network devices have no tunnels directly between them. The tunnels may be selectively formed, for example, between network devices through which data transmission occurs relatively more frequently, and/or a relatively large amount of data is transmitted. Meanwhile, if two network devices transmit data relatively less frequently, and/or at a relatively low volume or amount, then these two network devices may not have tunnels connecting them. The selective establishment of tunnels achieves a balance between computing overhead on one hand and data security and efficient data transmission on the other hand. As an initial step in determining a number of tunnels to be formed, the server may separate, partition, or demarcate network devices in a network into sections, portions, groups or cohorts (hereinafter “cohorts”). The formation of cohorts may reduce or minimize a number of tunnels while still maintaining transmission, either directly or indirectly via tunnels, through each of the network devices. Therefore, tunnels may be selectively established, formed or provisioned to save computing resources without compromising a range of communication between each of the network devices. Within each cohort, a leader may be selected, evaluated, and re-elected or switched periodically based on the evaluation. Tunnels among the leaders and among the network devices in a same cohort may be formed, while other tunnels may not be formed. Thus, the formation of cohorts sets, or clarifies, a guideline or criteria as to where tunnels are to be formed.

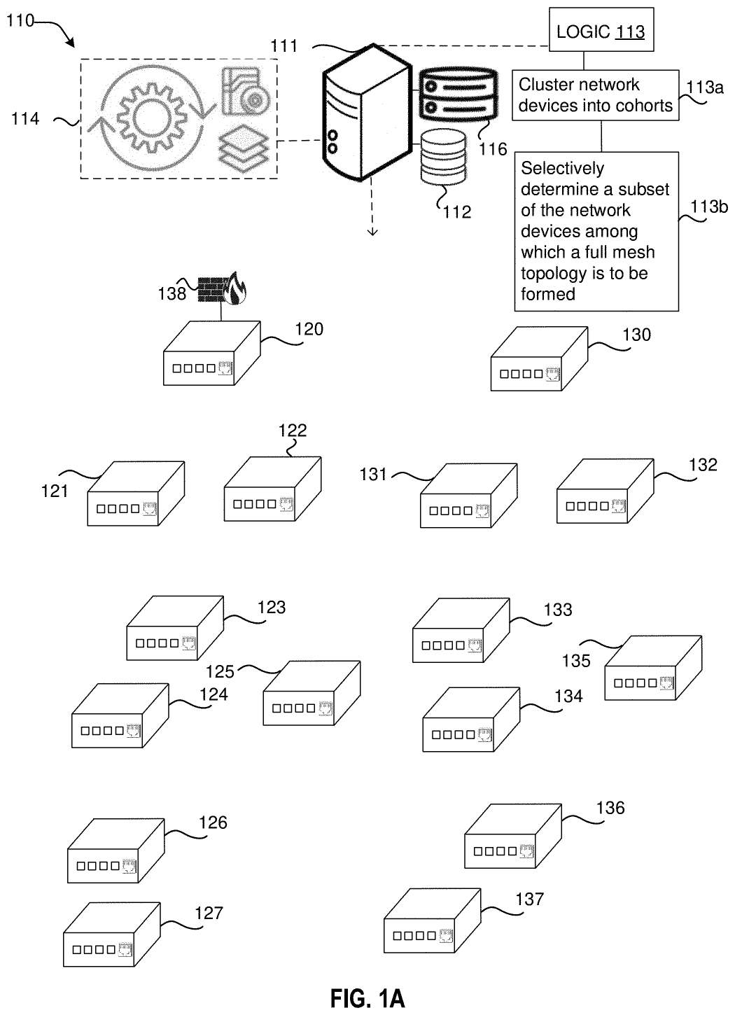

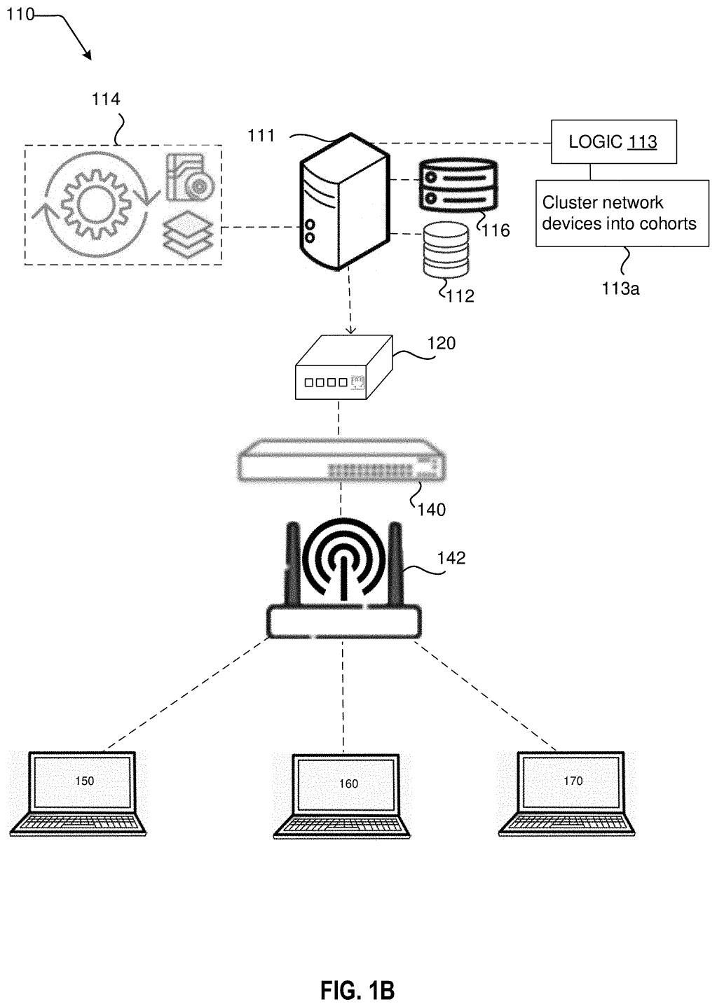

FIG. 1A is an exemplary illustration of computing system 110 including a computing component 111. While FIG. 1A illustrates an environment prior to a formation of cohorts, FIG. 1C illustrates an environment following the formation of cohorts. The computing component 111 may group network devices 120, 121, 122, 123, 124, 125, 126, 127, 130, 131, 132, 133, 134, 135, 136, and 137 (hereinafter 120-127, 130-137 when referred collectively) into cohorts by determining particular network devices to place in or assign to particular cohorts and a number of network devices to assign to each of the particular cohorts. The network devices 120-127, 130-137 may include routers or gateways within a network, such as a WAN or a SDWAN, in some examples. The network devices 120-127, 130-137 may include or be associated with firewalls. An example firewall 138 is illustrated as associated with the network device 120. Each of the other network devices 121-127, 130-137 may be associated with a same or similar firewall as the firewall 138). In some examples, the firewall 138 may utilize security rules not only on a level of a network device or a port, but also on a level of individual applications running on a network device or a client device connected to the network device. The security rules may indicate whether to permit or deny particular applications. The firewall 138 may inspect payloads within data packets, rather than only headers within the data packets. In some examples, the firewall 138 may filter data packets based on an application layer (e.g., layer 7) of the Open Systems Interconnect (OSI) model. The firewall 138 may also monitor for malicious activity within a network device based on signatures, activities or activity patterns, or behavior patterns.

The network devices 120-127, 130-137 may each constitute edge devices and/or separate branches of a WAN or a SDWAN. Although only 16 network devices are shown for the sake of illustration, any number of network devices may be contemplated. The computing component 111 may further provision tunnels or coordinate or initiate the formation thereof. Moreover, the computing component 111 may elect one of the network devices in each cohort as a leader. Each of the leaders communicates with leaders in other cohorts, and in an event of a failure, reroutes data in case the computing component 111 has not updated a topology that indicates particular routes through which traffic is routed. The computing component 111 may include one or more hardware processors and logic 113 that implements instructions to carry out the functions of the computing component 111. FIG. 1A illustrates or relates to some steps that may be executed by the logic 113, such as steps 113a and 113b.

In some examples, the computing component 111 may be associated with a platform or orchestrator 114 (hereinafter “orchestrator”). Any operations attributed to the computing component 111 may also be attributed to the orchestrator 114. In some examples, the orchestrator 114 may include services that use rules or policies (hereinafter “policies”) to automate tasks associated with separating the network devices 120-127, 130-137 into cohorts and selectively forming and provisioning tunnels between a subset of the network devices 120-127, 130-137. In particular, the orchestrator 114 may coordinate a workflow to organize the tasks. In some examples, the computing component 111 may implement policies, services, or microservices of the orchestrator 114, which may be comprised as part of the logic 113. The computing component 111 may include one or more physical devices or servers, or cloud servers on which services or microservices run. The computing component 111 may store, in a database 112, information such as information about a network, the network devices 120-127 and 130-137, the cohorts, which may include current data and/or historical data regarding the aforementioned. For example, the database 112 may include data of attributes, metrics, parameters, and/or capabilities of the network devices 120-127 and 130-137. In some examples, the computing component 111 may cache a subset of the data stored in the database 112 in a cache 116. For example, the computing component 111 may cache any of the data within the database 112 that may be frequently accessed, referenced, or analyzed, and/or may be frequently changing (e.g., having a higher than a threshold standard deviation and/or higher than a threshold variability with respect to time). Such data may include performance metrics, attributes, or parameters of the network devices 120-127 and 130-137.

FIG. 1B illustrates, relates to, or further elucidates some steps that may be executed by the logic 113, such as the step 113a. For example, FIG. 1B further elaborates on the functions of the network devices 120-127 and 130-137. In FIG. 1B, the network device 120 may function as a gateway for client devices 150, 160, and 170 to connect to a network such as a local area network (LAN). The network device 120 may be connected to one or more other routers or switches (hereinafter “switches”) 140 and one or more access points 142. The client devices 150, 160, and 170 may connect to the network via the one or more access points 142 and one or more switches 140. The switches 140 may detect and/or sequester rogue access points, and denylist rogue client devices. Meanwhile, the access points 142 may be implemented as VPN clients. Data traffic from client devices such as the client devices 150, 160, and 170 may be tunneled to a data center and aggregated by a corresponding VPN client at the data center. Although other network devices 121-127, 130-137 are not illustrated in FIG. 1B for the sake of simplicity, the other network devices 121-127, 130-137 may be implemented in a similar or same manner as that described above for the network device 120.

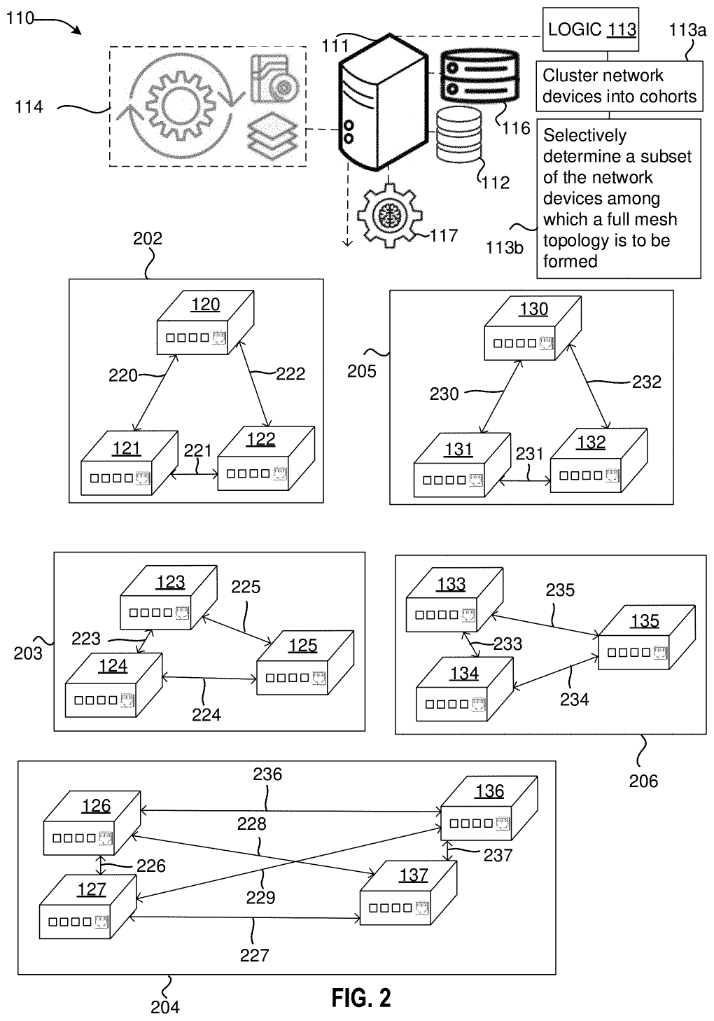

FIG. 2 illustrates, relates to, or further elucidates some steps that may be executed by the logic 113, such as the steps 113a and 113b. For example, FIG. 2 illustrates an implementation of the computing component 111 in determining a number of cohorts, assigning particular network devices to particular cohorts, and provisioning the tunnels by commencing the formation of the tunnels. In some examples, a criteria of determining a number of cohorts may be based on a number of total network devices to reduce a number of tunnels formed compared to a full mesh topology, while still maintaining a sufficient number of tunnels for every network device to communicate, via one or more tunnels, with any other network device. One other consideration may be that in each cohort, at least one network device is to form a tunnel with a network device in each of the other cohorts, so that transmission of data across cohorts may occur. In particular, the computing component 111 may determine a number of cohorts and/or a distribution of network devices into cohorts to attain a minimum number of tunnels given a total number of network devices, subject to the aforementioned restrictions that every network device can communicate, via tunnels, with any other network device either directly or indirectly, and that at least one network device is to form a tunnel with a network device in each of the other cohorts. Therefore, within each cohort, a tunnel is formed between every pair of network devices, just as in a full mesh topology. However, across different cohorts, some of the network devices do not have tunnels connecting them. Rather, only a single network device in a particular cohort may be tunneled to a single network device in each of the other cohorts. Thus, only a single network device in each cohort may directly communicate with respective network devices in each of other cohorts. In some examples, a number of network devices in any particular cohort may be restricted to be below a threshold value to maintain a standard of performance and prevent overloading in any particular cohort. For example, by setting a threshold number of network devices in a cohort, a leader, or any particular network device, may be prevented from being excessively burdened.

In FIG. 2, the computing component 111 may determine that, in a scenario with 16 network devices 120-127, 130-137, a minimum number of tunnels given the aforementioned restrictions is 84, assuming three uplinks per network device. To attain the minimum number of tunnels, the 16 network devices may be distributed with one cohort having four network devices and the other four cohorts having three network devices, as illustrated in FIG. 2. In the scenario of FIG. 2, the computing component 111 may determine that five cohorts 202, 203, 204, 205, and 206 (hereinafter “cohorts 202-206” when collectively referred to) are to be formed.

Such a distribution results in fewer tunnels compared to other scenarios. For example, having all 16 network devices being distributed in a single cohort or having each network device being distributed in a different cohort would amount to a full mesh topology in which 360 tunnels are formed. As another example, having 15 network devices being distributed in a first cohort and a single network device being distributed in a second cohort would result in 318 tunnels being formed. As another example, having 14 network devices being distributed in a first cohort and two network devices being distributed in a second cohort would result in 279 tunnels being formed. As yet another example, having four network devices each being distributed across four cohorts would result in 90 tunnels being formed, which is still more than the 84 tunnels in the distribution of FIG. 2. As a result of reducing a number of tunnels from 360 in a full mesh topology to 84 tunnels, a reduction of 77%, computing resources are accordingly conserved without affecting quality of service, connectivity, security, or user experience.

Next, the computing component 111 assigns each network device 120-127, 130-137 to a particular one of the five cohorts, in a clustering procedure, illustrated as cohorts 202, 203, 204, 205, and 206 in FIG. 2. Such a process may not be random, but rather may be based on criteria including characteristics such as 1) locations of each of the network devices 120-127, 130-137, 2) a software landscape, or software stack embedding, that would be formed as a result of an assignment of network devices into cohorts, 3) bandwidth consumed by different categories of applications, such as, between critical applications compared to non-critical applications, 4) traffic distributions and patterns, 5) a number of different device types behind, or connected to, each network device (e.g., mobile devices, tablets, VoIP, routers, or desktop computers), and/or 6) a reputation of a branch that includes all the network devices, or reputations of network devices within each of the cohorts. For example, a reputation may encompass historical performance parameters, attributes, or metrics such as uplink speed, uplink transmission rate, uplink jitter, uplink latency, uplink packet loss, and/or uplink average round trip time consumed by a packet transmission.

As a particular example, the computing component 111 may be more likely to cluster network devices 120-127, 130-137 that are located closer together with respect to one another into a common cohort. For instance, the computing component 111 may cluster all network devices 120-127, 130-137 that are located within a threshold distance of one another, such as, 500 feet. Alternatively, the computing component 111 may cluster all network devices 120-127, 130-137 based on radiofrequency (RF) neighbor data, which may encompass a group of network devices that can detect and recognize signals from one another of at least a threshold level, such as negative 80 decibels relative to milliwatt (dBm).

Next, regarding the software landscape, the computing component 111 may be more likely to cluster network devices 120-127, 130-137 that have same or similar embedded software into a common cohort. In such a manner, network devices within a common cohort may be more likely to have compatible software, and thus, may communicate more effectively with one another. Furthermore, regarding the bandwidth consumed by different categories of applications, the computing component 111 may be more likely to cluster network devices 120-127, 130-137 that tend to have similar bandwidth consumption patterns, such as, amounts or proportions of total bandwidth consumed on particular applications. Moreover, regarding the traffic distributions or patterns, the computing component 111 may be more likely to cluster network devices 120-127, 130-137 that tend to have similar traffic distributions or patterns. For example, the traffic patterns may be relative to a time of day, such as, a relative frequency of traffic patterns during daytime compared to nighttime. In another example, the traffic distributions or patterns may indicate relative and/or total amounts of traffic consumed across different categories of traffic, such as, data transmission, video, and voice, and how traffic consumption varies over time and/or cyclically. Next, regarding the number of different device types, the computing component 111 may be more likely to cluster network devices 120-127, 130-137 that have similar types or distributions or proportions of device types connected. Lastly, regarding the reputation, the computing component 111 may be more likely to cluster network devices 120-127, 130-137 that have similar reputations, in an effort to distribute load over a cohort more evenly. In a particular example, if a network device within a cohort has a low reputation but a second network device within the cohort has a high reputation, then data traffic may be diverted, disproportionately, to the second network device.

Such criteria may be determined based on historical data, which, for example, may be stored in the database 112 and/or cached in the cache 116. An objective of selectively assigning client devices to particular cohorts may be that network devices within each of the cohorts may have or be associated with similar characteristics, whether of the network devices themselves or associated client devices or LANs so that loads upon each of the network devices may be roughly evenly distributed and the performance and/or other characteristics in a particular cohort may be predictable. For example, if a first network device in one cohort has different characteristics compared to a second network device, such as amounts of traffic or types of client devices that are supportable, then one network device may have to bear an unreasonably high load while the other network device may be unable to support or limited in its ability to support certain functions requested by the client devices.

In some examples, attributes of the software landscape, or software stack embedding, may include any of an operating system (OS) version, a software version, corresponding user accounts, a Kernel version, OS registry databases, .plist files, running processes, Daemon, background, and persistent processes, startup operations, launched entries, application and system errors encountered, DNS lookups, and/or network connections of or associated with client devices. Meanwhile, the traffic pattern may be determined based on a protocol type, a service, flags, a number of source bytes, a number of destination bytes, frequencies of occurrence of incorrect fragments, packet counts per transmission or over a period of time, packet sizes per packet, receiver error rates, types of data transmitted (e.g., media or textual data) and/or fluctuations such as spikes in traffic. Furthermore, a reputation of a network device may be determined based on a total number of unpermitted applications accessed at that network device, a total number of malware or suspected malware URL (universal resource link) requests at the network device, a total number of banned file attachments and/or MIME types used in emails or other communications, a total number of anomalous intrusions detected on client devices connected to the network device, and/or a total number of sensitive data breaches detected on the network device. These attributes or parameters may be summed after individually being weighted. The weights may be based on a relative importance of each of the attributes or parameters, which may be the same across all network devices or specific to a particular network device. For example, in a particular network device, a consideration of unpermitted applications may be especially deemed important and thus be weighted heavily. These attributes or parameters may be measured according to a raw number over a given amount of time, such as within the last day, ten days, or month, or according to a frequency of occurrence, adjusted based on a data throughput on the network device.

In some examples, the computing component 111 may implement an artificial intelligence (AI) or a supervised and trained machine learning model 117 that incorporates factors 1) through 6) described above to determine an assignment of network devices into cohorts. The machine learning model may be trained, either sequentially or in parallel, using two different training datasets. A first training dataset may include situations or scenarios in which a network device is assigned to a particular cohort because of sufficient similarities between the attributes of the network device and those of other network devices within the cohort. A second training dataset may include situations or scenarios in which a network device is not assigned to a particular cohort due to more than a threshold degree of differences between the attributes of the network device and those of other network devices within the cohort. In some examples, the machine learning model may further be trained based on feedback, following the assignment of network devices into cohorts, regarding certain performance attributes. These performance attributes may include, packet transmission rate or speed, network speed, packet drop rates, frequencies of occurrence of incorrect fragments, packet counts per transmission or over a period of time, receiver error rates, and/or fluctuations such as spikes in traffic or packet sizes, over a particular cohort and/or across multiple cohorts. For example, the machine learning model may receive feedback that certain performance attributes may fail to satisfy a threshold level or measure, and modify or adapt its criteria in assigning network devices into cohorts. In some scenarios, the machine learning model 117 may be trained based on the performance attributes. For example, if a particular parameter such as packet transmission rate or speed failed to satisfy a threshold standard or threshold, the machine learning model 117 may be trained to weight that parameter more heavily in assigning network devices to cohorts. The computing component 111 may automatically implement, without user input, the determined assignment of network devices into cohorts, or alternatively, provide a recommendation to a user regarding such so that the user may manually implement the recommendation.

In the example scenario of FIG. 2, the computing component 111 may determine that the network devices 120, 121, and 122 (hereinafter “120-122” when referred to collectively), are assigned to the cohort 202, the network devices 123, 124, and 125 (hereinafter “123-125” when referred to collectively) are assigned to the cohort 203, the network devices 126, 127, 136, and 137 (hereinafter “126-127, 136-137” when referred to collectively) are assigned to the cohort 204, the network devices 130, 131, and 132 (hereinafter “130-132” when referred to collectively) are assigned to the cohort 205, and the network devices 133, 134, and 135 (hereinafter “133-135” when referred to collectively) are assigned to the cohort 206. Each network device in a common cohort may be assigned or labelled with a same identifier (ID). In some embodiments, a network device may be part of multiple distinct branches or cohorts.

The computing component 111 may provision tunnels or initiate the formation thereof by generating or computing unique keys, such as symmetric keys, corresponding to each tunnel to be formed between a pair of network devices. Once that pair of network device receives the keys, they may exchange encrypted data in order to validate the keys. Once the keys are validated, then the tunnel may be formed. The computing component 111 then transmits the generated keys to any of the network devices between which a tunnel is to be formed. In some examples, the computing component 111 may determine that tunnels are to be formed within a cohort (e.g., each of the cohorts 202-206) such that each network device within a cohort can transmit data directly to any other network device within that cohort. In other examples, as illustrated in FIG. 2, the computing component 111 may determine that tunnels are to be formed within a cohort in order to implement or attain a full mesh topology within each cohort, but not across different cohorts. In other words, each of the network devices within a cohort may be connected according to a full mesh topology but any network devices that do not share a common cohort, or that were not assigned to a common cohort, may not be connected according to a full mesh topology. In the scenario of FIG. 2, the computing component 111 may determine that bidirectional tunnels 220, 221, 222, 223, 224, 225, 226, 227, 228, 229, 230, 231, 232, 233, 234, 235, and 236 (hereinafter “220-236” when referred to collectively) are to be formed. Within the cohort 202, the tunnel 220 may be formed between the network devices 120 and 121. The tunnel 221 may be formed between the network devices 121 and 122. The tunnel 222 may be formed between the network devices 120 and 122. Within the cohort 203, the tunnel 223 may be formed between the network devices 123 and 124. The tunnel 224 may be formed between the network devices 124 and 125. The tunnel 225 may be formed between the network devices 123 and 125. Within the cohort 204, the tunnel 226 may be formed between the network devices 126 and 127. The tunnel 227 may be formed between the network devices 127 and 137. The tunnel 228 may be formed between the network devices 126 and 137. The tunnel 229 may be formed between the network devices 127 and 136. The tunnel 236 may be formed between the network devices 126 and 136. Within the cohort 205, the tunnel 230 may be formed between the network devices 130 and 131. The tunnel 231 may be formed between the network devices 131 and 132. The tunnel 232 may be formed between the network devices 130 and 132. Within the cohort 206, the tunnel 233 may be formed between the network devices 133 and 134. The tunnel 234 may be formed between the network devices 134 and 135. The tunnel 235 may be formed between the network devices 133 and 135. In such a manner, any network devices within a particular cohort are fully meshed to other network devices in that particular cohort, thereby facilitating seamless communication among devices within a common cohort.

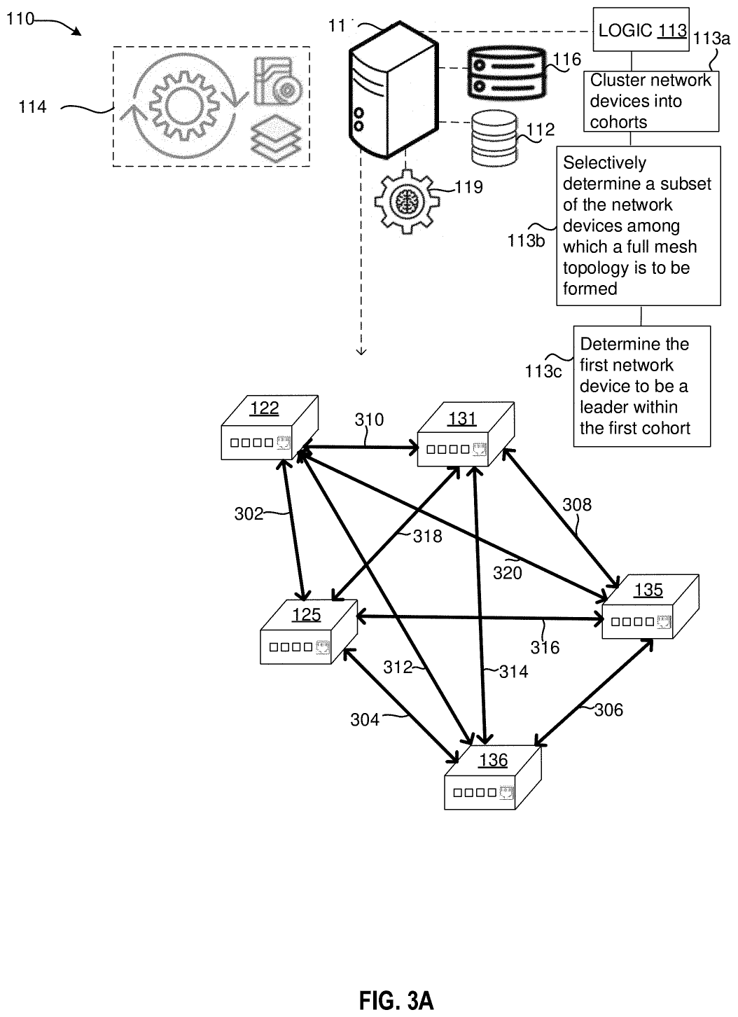

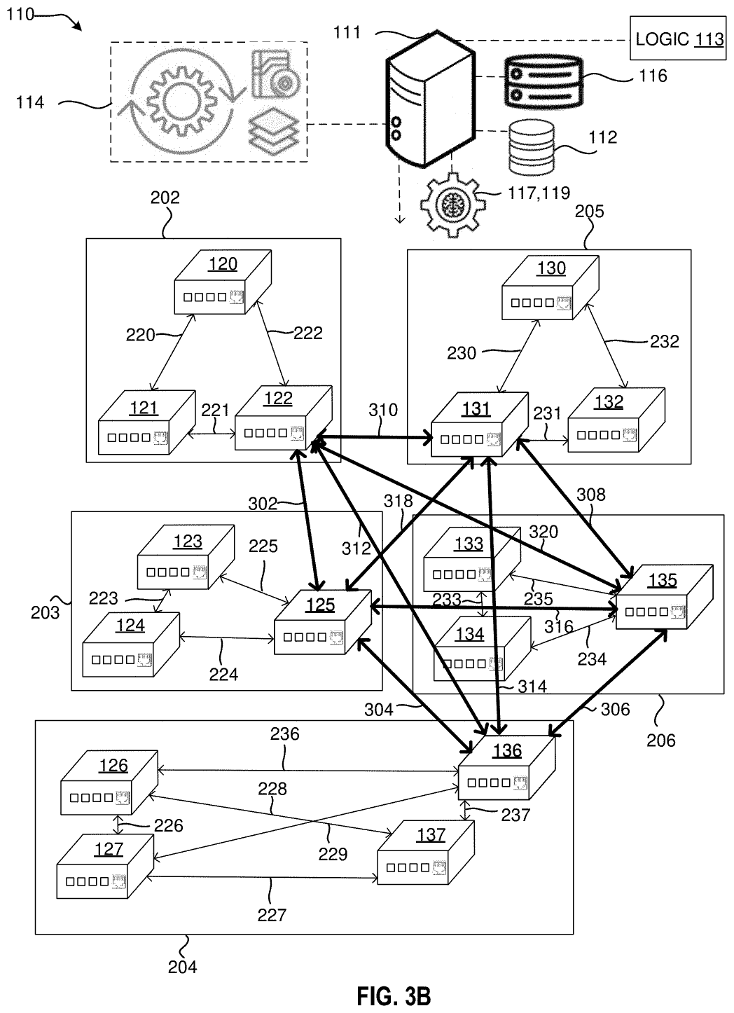

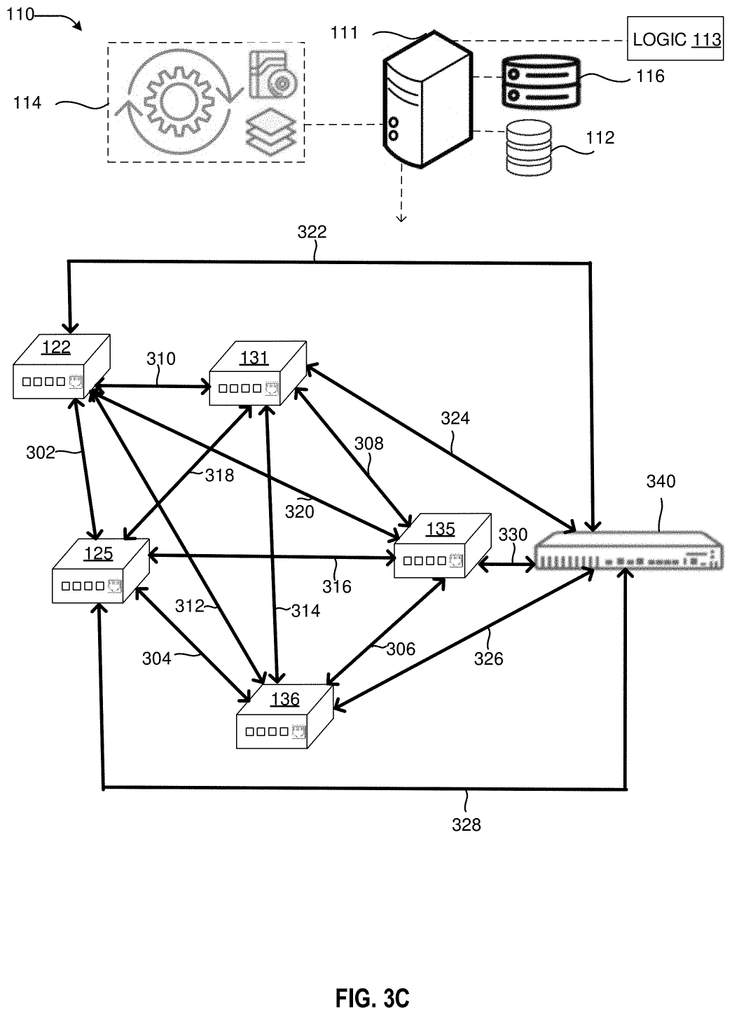

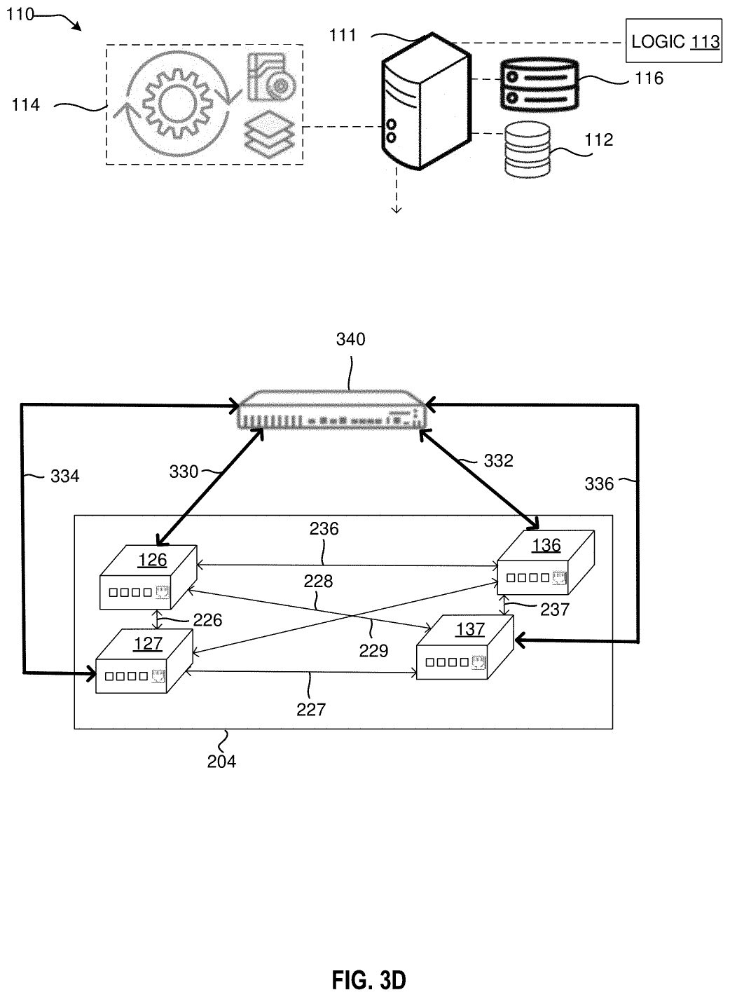

FIG. 3A illustrates, relates to, or further elucidates some steps that may be executed by the logic 113, such as the steps 113a and 113b, and step 113c. For example, FIG. 3A illustrates a scenario in which the computing component 111 appoints a single leader in each of the cohorts 202-206. FIG. 3A may be implemented in addition to the implementations illustrated in FIG. 2, and in conjunction with FIGS. 1A and 1B. A leader in each cohort may be fully meshed to other leaders in the other cohorts, and responsible for communications and/or data transmissions between different cohorts. Thus, any request to exchange data from a particular client device at a first cohort to a different client device in a second cohort may be passed through a first leader of the first cohort, which transmits the request to a second leader of the second cohort. For example, in FIG. 3A, the computing component 111 may appoint the network device 122 as the leader of the cohort 202, the network device 125 as the leader of the cohort 203, the network device 136 as the leader of the cohort 204, the network device 131 as the leader of the cohort 205, and the network device 135 as the leader of the cohort 206. Thus, the computing component 111 may appoint or select only a single network device as a leader of an individual cohort. The computing component 111 may transmit the information regarding the identities of the leaders, to the orchestrator 114, which propagates the information to all network devices 120-127, 130-137. Thus, all network devices 120-127, 130-137 will know or discover that the network devices 122, 215, 131, 135, and 136 were appointed as leaders. The leaders may be provisioned, by the computing component 111, to receive updated statuses regarding tunnels between network devices. In particular, if a non-leader network device transmits, to the computing component 111, an indication regarding the updated statuses of tunnels between the network devices, the computing component 111 may transmit the update to the leader.

The criteria to determine whether or not a network device should be appointed as a leader, or to select a network device in a cohort among different network devices, may include parameters or attributes such as available amounts of bandwidth, memory, and available computing resources such as CPU cycles of the network devices, uplink speed, uplink jitter, uplink latency, uplink packet loss, uplink average round trip time consumed by a packet transmission, consumption of bandwidth, memory, or computing resources, models of the network devices, and/or software versions of the network devices. In some examples, historical data of, or indicative of, these parameters may be utilized to determine the appointment of a network device as a leader. In some examples, the machine learning model 119 may predict respective future parameters based on the historical data, and/or trends across the historical data. The determination of which network device to appoint as a leader may be based on the predicted future parameters, which may be indicative of a predicted future performance, and/or historical data regarding the parameters. In some examples, a network device having among lowest computing loads and/or among best performances, and/or lowest predicted future computing loads and/or best or highest predicted performances, as measured by the aforementioned parameters or attributes, may be selected as a leader for a particular cohort. Upon determination of leaders of the cohorts 202-206, the computing component 111 may commence the formation of bidirectional tunnels to create a fully meshed network among the leaders, as illustrated in FIG. 3A, by computing and transmitting keys in a similar process as that used to create the tunnels for the network devices within a common cohort. In particular, the computing component 111 may transmit keys to the network devices 122 and 125, and when data is exchanged using the keys by the network devices 122 and 125, a tunnel 302 may be formed. Similarly, a tunnel 304 may be formed between the network devices 125 and 136. A tunnel 306 may be formed between the network devices 136 and 135. A tunnel 308 may be formed between the network devices 135 and 131. A tunnel 310 may be formed between the network devices 131 and 122. A tunnel 312 may be formed between the network devices 122 and 136. A tunnel 314 may be formed between the network devices 131 and 136. A tunnel 316 may be formed between the network devices 125 and 135. A tunnel 318 may be formed between the network devices 125 and 131. A tunnel 320 may be formed between the network devices 122 and 135.

In some examples, the appointment of a leader of a cohort may be implemented using an AI or a machine learning model (hereinafter “machine learning model”) 119. The machine learning model 119 may be trained, either sequentially or in parallel, using two different training datasets. A first training dataset may include situations or scenarios in which a network device is assigned as a leader. A second training dataset may include situations or scenarios in which a network device is not assigned as a leader. Thus, the machine learning model 119 may be able to distinguish between different situations or contexts in which a network device is to be appointed as a leader, compared to situations or contexts in which a network device is not to be appointed as a leader. In some examples, the machine learning model 119 may further be trained based on feedback, following the determination of leaders, regarding certain performance attributes or metrics of the determined leader. These performance attributes may include, packet transmission rate or speed, network speed, packet drop rates, frequencies of occurrence of incorrect fragments, packet counts per transmission or over a period of time, receiver error rates, and/or fluctuations such as spikes in traffic or packet sizes, over a particular cohort and/or failure or error rates of the determined leader. For example, the machine learning model may receive feedback that a network device determined or appointed as a leader fails to satisfy certain performance attributes and modify or adapt the criteria in determining a leader. The computing component 111 may automatically determine and assign particular network devices as respective leaders of different cohorts, without user input, or alternatively, provide a recommendation to a user regarding such so that the user may manually implement the recommendation.

The computing component 111 may continuously, or periodically, monitor performance metrics or parameters of the determined leader of each cohort. If one or more parameters, and/or an overall measure of performance, of the determined leader fail to satisfy one or more performance attributes, parameters, standards or thresholds, and/or if the determined leader becomes inoperative (e.g., unreceptive or unable to transmit data), then the computing component 111 may selectively switch out the current leader and predetermine or appoint a different leader using a same or similar criteria as the determination of a leader alluded to previously (e.g., one or more performance parameters or attributes). In some embodiments, the machine learning model 119 may be trained based on the parameters of the determined leader of each cohort. For example, if a particular parameter such as uplink jitter failed to satisfy a threshold standard or threshold, the machine learning model 119 may be trained to weight that parameter more heavily in redetermining a leader.

If a new leader of a particular cohort is selected or determined, the computing component 111 may generate and transmit new keys so that the new leader may form tunnels with each of the other leaders. In some examples, the computing component 111 may implement a make-before-break strategy or mechanism, in which the computing component 111 may determine or verify that the new tunnels become fully functional prior to breaking down existing tunnels with the previous leader.

FIG. 3B illustrates how the implementations of FIG. 3A and FIG. 2 may be combined. Thus, FIG. 3B illustrates that the tunnels 220-227, 230-237, as described with respect to FIG. 2, form a fully meshed network among all network devices in a common cohort. Meanwhile, the tunnels 302, 304, 306, 308, 310, 312, 314, 316, 318, and 320 form a fully meshed network among all leaders 122, 125, 131, 135, and 136 of different cohorts 202, 203, 205, 206, and 204, respectively. Meanwhile, no tunnels may be formed between non-leader network devices in different cohorts. The implementation illustrated in FIG. 3B facilitates efficient and effective data transmission without consuming excessive computing resources, and constitutes a resource savings of 77% compared to a scenario of a complete full mesh topology over all network devices 220-227, 230-237.

Upon formation of the tunnels 220-227, 230-237, and the tunnels 302, 304, 306, 308, 310, 312, 314, 316, 318, and 320, the computing component 111 and/or the orchestrator 114 may determine or obtain information regarding routes of data transmission which include all the aforementioned tunnels. The information regarding routes may include all possible routes, regardless of whether the routes are operational. The information regarding routes may be updated, for example, if new network devices are introduced, network devices are removed, and/or tunnels are formed or removed. The computing component 111 or the orchestrator 114 may propagate or advertise the information to all network devices 120-127, 130-137. The computing component 111 or the orchestrator 114 may further receive information regarding a topology. The topology information may include both an advertisement regarding nodes (e.g., information regarding the network device itself such as an identity of the network device) and an advertisement regarding links (e.g., the tunnel or the interface information of the network device, such as whether the tunnel is operational).

In some examples, a link (e.g., tunnel) between two network devices will be construed or considered by the computing component 111 or the orchestrator 114 to be working, operational, or up (hereinafter “operational”), only when both the network devices report that link to be operational, as part of the link advertisement. Each network device may transmit such link information using a protocol such as Overlay Agent Protocol. Referring to FIG. 2, if the network device 122 reports that the tunnel 222 is operational between that network device 122 and the network device 120, but the network device 120 reports that the tunnel 222 is inoperational, or fails to report a status of the tunnel 222, then the tunnel 222 may be determined and marked by the computing component 111 or the orchestrator 114 as being inoperational, and will not be part of the topological database. However, if the tunnel 222 later becomes restored, then the tunnel 222 will be added or re-added to the topology database. In some scenarios, if the pair of network devices (e.g., 120 and 122) is linked by multiple tunnels, then if any one tunnel is operational, then the orchestrator 114 may determine the status of a link corresponding to that pair of network devices as operational. Otherwise, if all the tunnels between that pair of network devices are inoperational, then the orchestrator may remove the link from the topological database.

Once the computing component 111 or the orchestrator 114 receives the topology information from each of the network devices 120-127, 130-137, the computing component 111 or the orchestrator 114 may create or form a topological diagram or database. The topological diagram or database may be manifested as a connected graph or a connectivity graph of the network devices 120-127, 130-137 within that branch mesh topology. The connectivity graph may be based on current tunnel statuses between the network devices. The topological diagram or database may be augmented or overlaid with link costs to transport or transmit data packets between any two network devices 120-127, 130-137. The costs may represent computing costs of data transmission along each of the links connecting two network devices. In some examples, a cost to transmit data between two network devices of a common cohort (e.g., between the network devices 120 and 122 in the cohort 202 of FIG. 2) is 1, a cost to transmit data between two cohort leaders (e.g., between the network devices 125 and 131 of FIG. 3A) is 15, and a cost to transmit data between a hub and spoke is a multiple of 10, depending on a priority or preference of the hub, as illustrated in FIGS. 3C and 3D. For example, a cost to transmit data between a primary hub and a spoke (e.g., between a node 340 and the network device 330) may be 10. A cost to transmit data between a secondary hub and a spoke may be 20. A cost to transmit data between a tertiary hub and a spoke may be 30, and so on.

The computing component 111 or the orchestrator 114 may distribute, publish, or propagate the topological diagram or database to every network device (e.g., the network devices 120-127, 130-137) within the branch mesh topology. The orchestrator 114 or the computing component 111 may transmit, to the network devices, updates regarding tunnel statuses, only when changes are occurring in the network. The transmission of the topological database updates to the network devices may occur at a higher priority compared to updates regarding route statuses. The computing component 111 or the orchestrator 114 may create and/or store multiple topological diagrams or databases (hereinafter “topological databases”), each of which corresponds to a different branch mesh topology. Each of the topological diagrams or databases may be stored and maintained in a unique database. If a network device is part of two different branch mesh topologies at a same time, the computing component 111 or the orchestrator 114 may publish both topological diagrams or databases, which correspond to the two different branch mesh topologies, to that network device.

After a network device (e.g., any of the network devices 120-127, 130-137) receives the topological diagrams or databases, the network device may calculate a shortest path to route data by using an algorithm, such as Dijkstra's Shortest Path First (SPF) algorithm. In some examples, a shortest path may be based on a lowest total cost to route data from the network device to a destination. If the transmission of data requires multiple hops, meaning that the transmission goes through one or more intermediate or intervening network devices, then the algorithm may be used to select a subsequent hop. The calculation of the shortest path may be based on links within the topological database, and may only consider links that are construed or considered as being working or up.

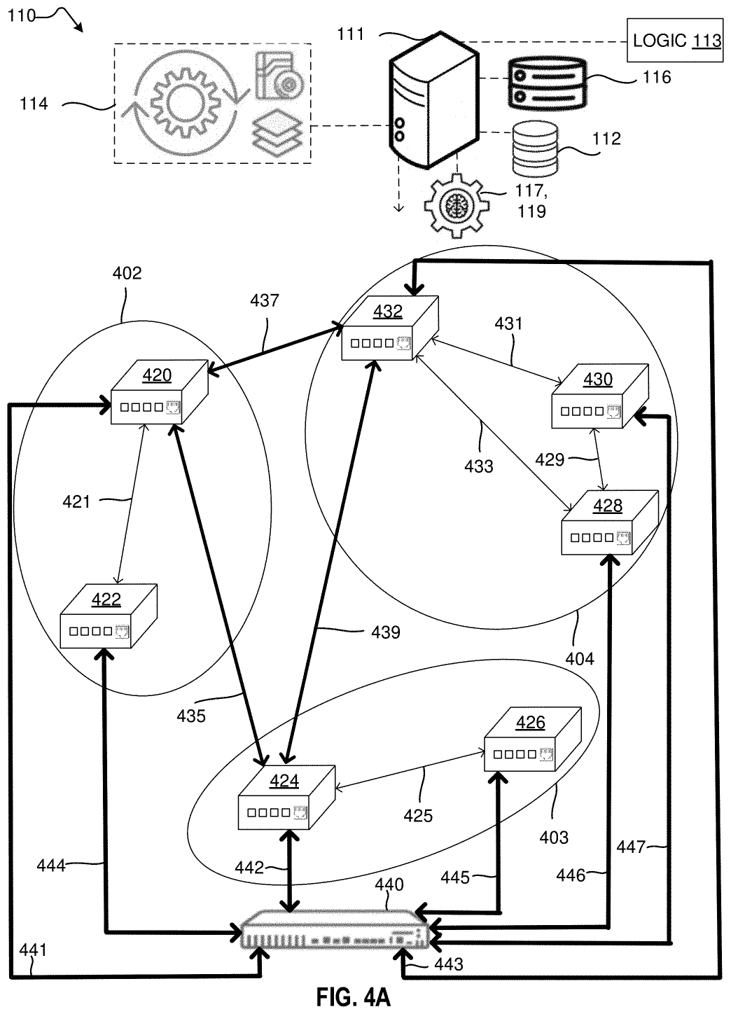

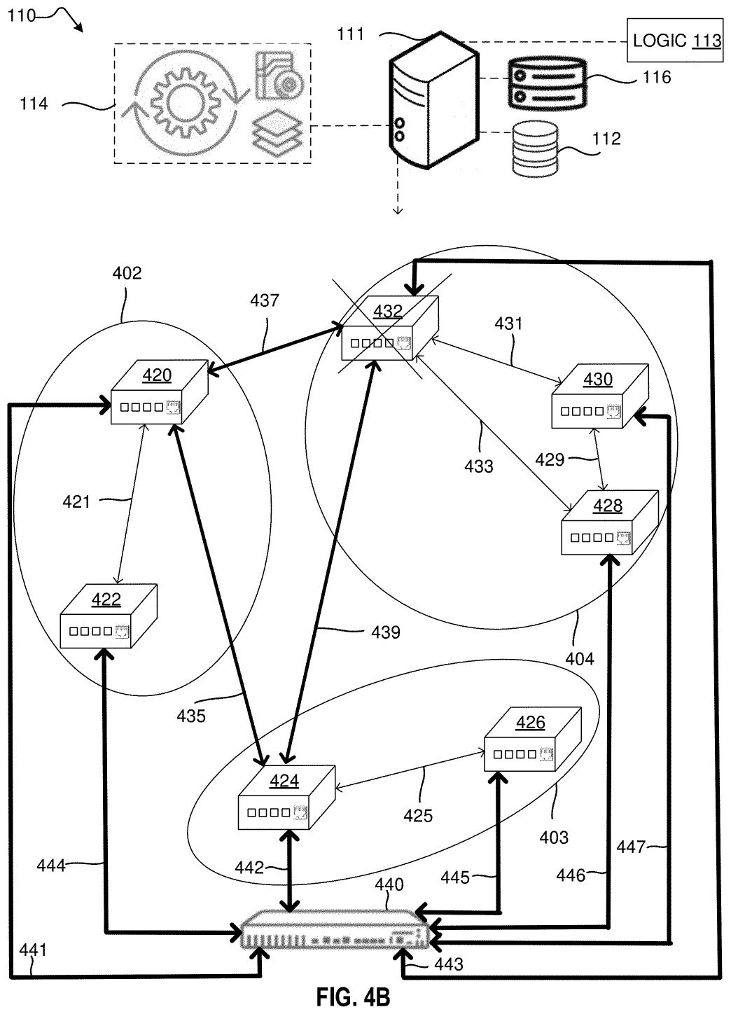

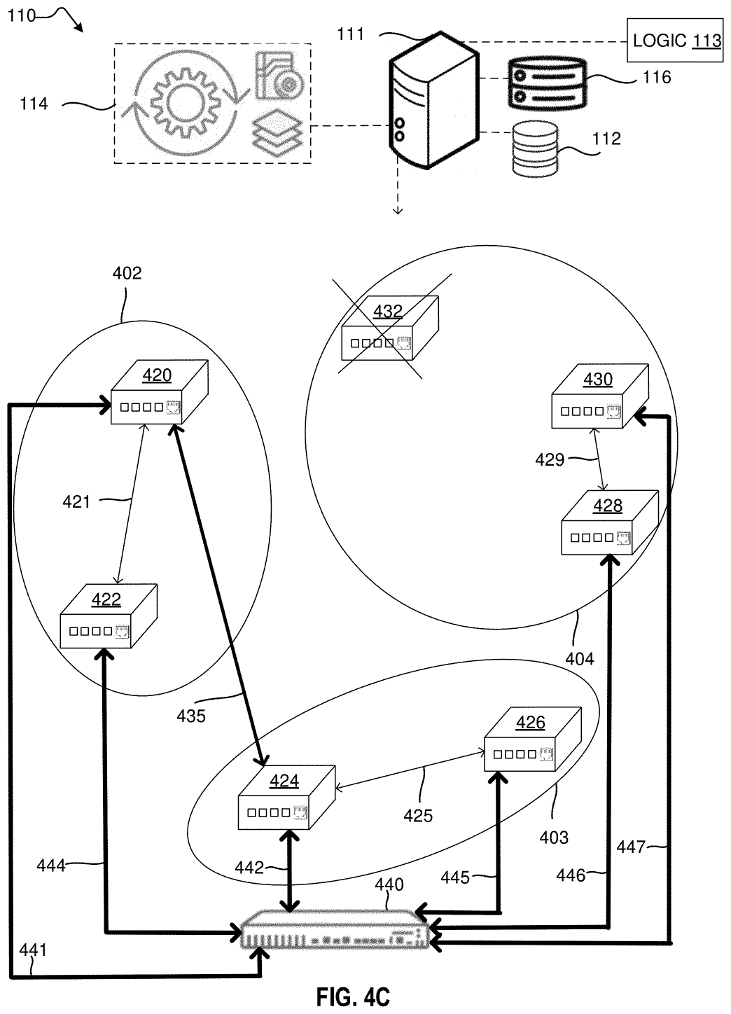

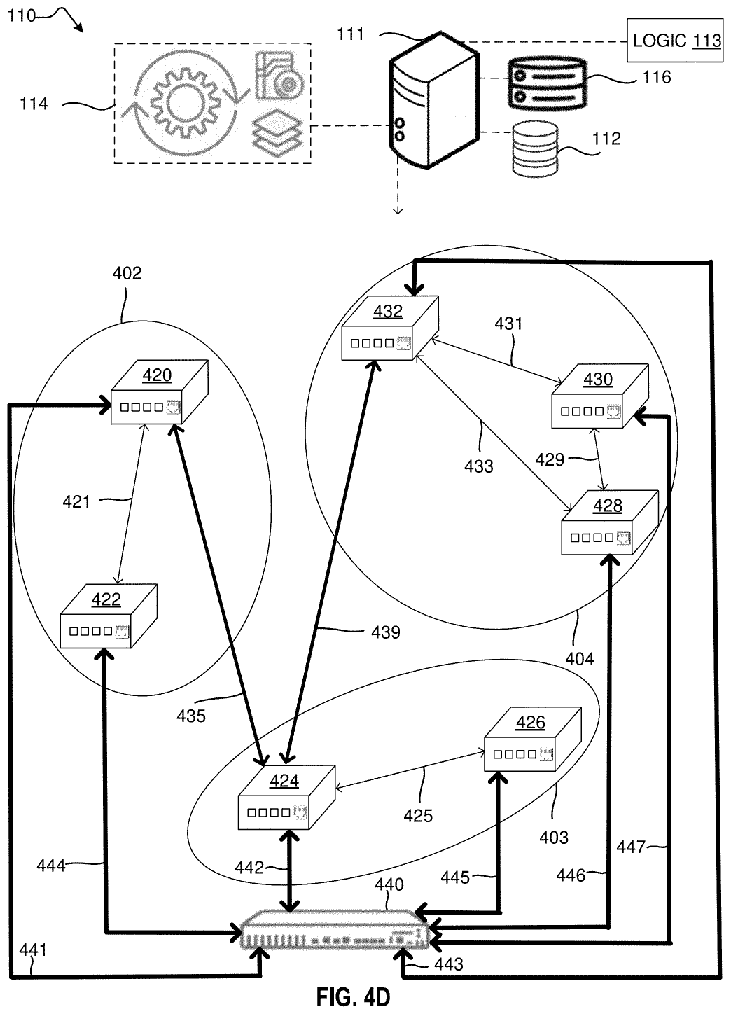

In some examples, the network devices determined to be leaders may receive information regarding other leaders, or tunnels between leaders, becoming inoperational, via Dead Peer Detection (DPD). In such examples, the leaders may shunt data to alternative paths such as through a node or a data center, as will be illustrated in FIGS. 4A-4C, in order to avoid transmission to the inoperational network devices. DPD packets may be transmitted by the network devices at periodic intervals, such as every 15 seconds, to ascertain a status of whether the tunnels are operational. Every network device may compute and update a routing table indicating possible data transmission paths, based on DPD packets and/or updates from the computing component 111 or the orchestrator 114.

FIGS. 3C and 3D illustrate a connection between cohorts and a node 340 such as a centralized node. FIG. 3C may be implemented in conjunction with any of the previous figures, including FIGS. 1A, 1B, 2, 3A, and 3B, which do not illustrate a centralized node for simplicity. The node 340 may constitute a data center, which may be connected via tunnels to a subset of (e.g., any or all of) the network devices 120-127, 130-137. In FIG. 3C, the node 340 is illustrated as only connected to the network devices 122, 125, 131, 135, and 136, via tunnels 322, 328, 324, 330, and 326, respectively. However, the node 340 may also connect to other network devices such as the non-leader network devices in a same or similar manner. For example, in FIG. 3D, the node 340 may be connected to the non-leader network devices 126, 127, 136, and 137 via tunnels 330, 334, 332, and 336, respectively. The node 340 may be connected to the non-leader network devices 126, 127, 136, and 137 permanently. The node 340 may also connect to other non-leader network devices in a same or similar manner. In some examples, the centralized node 340 may include a client, such as a VPN client, and a server. The VPN client may terminate IPSec tunnels and/or aggregate data traffic from the access points (e.g., the access point 142 in FIG. 1B). As will be described further with reference to FIGS. 4A-4D, tunnels through the centralized node 340 may be an alternative data transmission pathway if any of the leaders become inoperational. Although only one centralized node 340 is illustrated for simplicity, multiple centralized nodes may be implemented within a network. The multiple centralized nodes may each by connected via tunnels to a subset of (e.g., any or all of) the network devices 120-127, 130-137. In some examples, a number of tunnels formed from the network devices to the node 340 may not be considered in the determination of a number and distribution of cohorts.

FIGS. 4A-4D may be implemented in conjunction with any of the principles described with regard to FIGS. 1A, 1B, 2, and 3A-3D. FIGS. 4A-4D elucidate a scenario in which a network device or a tunnel becomes inoperational and the computing component 111 or the orchestrator 114 updates routes of data transmission to avoid the inoperational network device or the inoperational tunnel. FIG. 4A illustrates an exemplary network having network devices 420, 422, 424, 426, 428, 430, and 432, all of which may be implemented in a similar or same manner as the network devices 120-127, 130-137 illustrated in the previous FIGS. 1A, 1B, 2, and 3A-3D. The network devices 420 and 422 may be grouped into a cohort 402. The network devices 424 and 426 may be assigned to a cohort 403. The network devices 428, 430, and 432 may be assigned to a cohort 404. In a scenario of seven network devices, a distribution of two cohorts having two network devices each and one cohort having three network devices may provide a minimum number of tunnels (24 tunnels assuming 3 uplinks per network device) compared to other distributions, while still implementing a full mesh topology among network devices in a same cohort and a full mesh topology among leaders of different cohorts. Here, the network devices 420, 424, and 432 may be assigned or determined to be leaders of the cohorts 402, 403, and 404, respectively. The assignment of network devices to cohorts and the determination of leaders of each of the cohorts may be performed in a same or similar manner as that described with reference to FIGS. 2 and 3A-3D. Here, tunnels 421, 425, 429, 431, and 433 may be formed among network devices in a same cohort, while tunnels 435, 437, and 439 may be formed among the network devices determined to be leaders. Meanwhile, a node 440 such as a data center, which may be implemented as the node 340 of FIGS. 3C-3D, may also be connected to each of the network devices 420, 422, 424, 426, 428, 430, and 430 via tunnels 441, 444, 442, 445, 446, 447, and 443, respectively.

FIG. 4B-4C illustrate a scenario in which one of the network devices, the network device 432, has become inoperational. In FIG. 4B, the network devices 420 and 424 may detect that the network device 432 has become inoperational via DPD packets, which may not be transmitted from the network device 432. The network devices 420 and 424 may also broadcast, to the computing component 111 or the orchestrator 114, that the tunnels 437 and 439 previously connected to the network device 432 are now inoperational. Additionally, the network devices 430 and 428 may advertise to the computing component 111 or the orchestrator 114 that the tunnels 431 and 433 previously connected to the network device 432 are now inoperational. The computing component 111 or the orchestrator 114 may then remove the tunnels 437, 439, 431, and 433, as illustrated in FIG. 4C. The computing component 111 or the orchestrator 114 may determine a new leader of the cohort 404, and generate and transmit keys to initiate formation of new tunnels between the new leader and the other leaders, the network devices 420 and 424. The computing component 111 or the orchestrator 114 may update the topological database and determine new paths for data transmission as a result of the network device 432 being in a failed status. The new paths may be determined both before and after the formation of new tunnels between the new leader of the cohort 404 and the network devices 420 and 424. Meanwhile, to prevent or mitigate delays resulting from the determination of new paths, each of the existing leaders, the network devices 420 and 424, may determine alternative data transmission paths that bypass the failed network device 432 and the removed tunnels 437, 439, 431, and 433, such as data transmission paths of lowest cost, which may go through the node 440. Due to the removed tunnels, communication between two network devices in different cohorts, such as between the network devices 420 and 430, which previously (e.g., prior to the failure of the network device) went through the network device 432, may occur via a hub-and-spoke manner. As another particular illustrative example, a request for data exchange from the network device 422 to the network device 430 may have previously gone through the network device 432. However, the network device 420 may determine an alternate path, in which the data is transmitted from the network device 422 to the network device 420 via the tunnel 421, to the node 440 via the tunnel 441, and lastly, from the node 440 to the network device 430 via the tunnel 447. In such a manner, traffic loss and delays may be prevented or mitigated even in an event of a network device failure. The relatively high cost of 15 to transmit data between cohort leaders may prevent overloading of a cohort leader and facilitate faster traffic convergence during failure of a network device or a tunnel. In the event of such a failure, a backup path may be determined by a network device (e.g., the network device 420) via the node 440, due to the next-best available cost path being via the node 440.

Similarly to FIGS. 4B and 4C, in FIG. 4D, as a result of a tunnel, such as the tunnel 437 becoming inoperational, the computing component 111 or the orchestrator 114 may update the topology and determine new paths for data transmission. Furthermore, the computing component 111 or the orchestrator 114 may then determine new leaders in the cohorts between which communication has been disrupted (e.g., the cohort 402 and/or the cohort 404). The new paths may be determined both before and after the formation of new tunnels between the new leaders and the network device 424. Alternatively, the computing component 111 or the orchestrator 114 may refrain from, or determine not to, assign new leaders, and create a new tunnel between the network devices 420 and 432. The network devices 420 and 432 may, to prevent or mitigate delays resulting from the determination of new paths, determine alternative data transmission paths that bypass the tunnel 437, such as data transmission paths of lowest cost, which may go through the node 440. As a particular illustrative example, a request for data exchange from the network device 422 to the network device 430 may have previously gone through the tunnel 437. However, the network device 420 may determine an alternate path, in which the data is transmitted from the network device 422 to the network device 420 via the tunnel 421, to the node 440 via the tunnel 441, and lastly, from the node 440 to the network device 430 via the tunnel 447. In such a manner, traffic loss and delays may be prevented or mitigated even in an event of a tunnel failure.

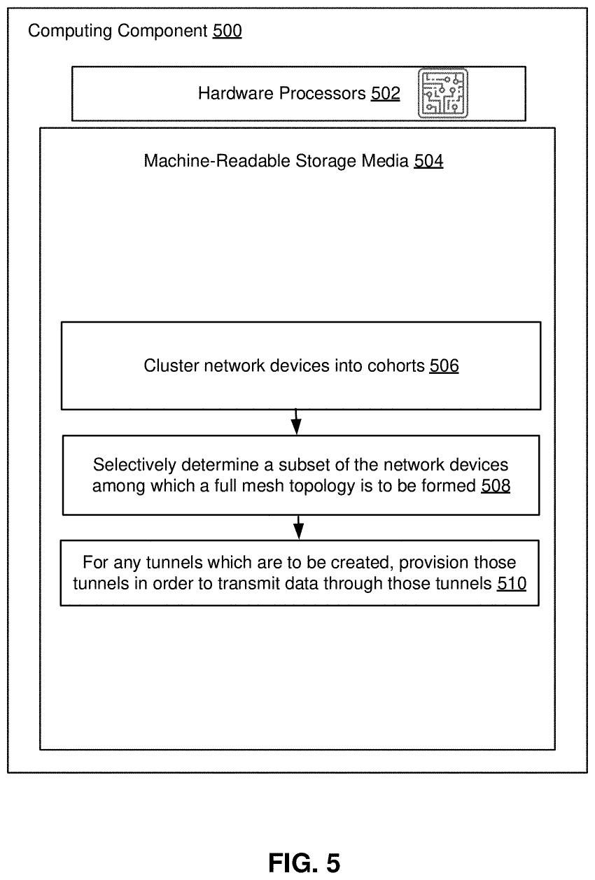

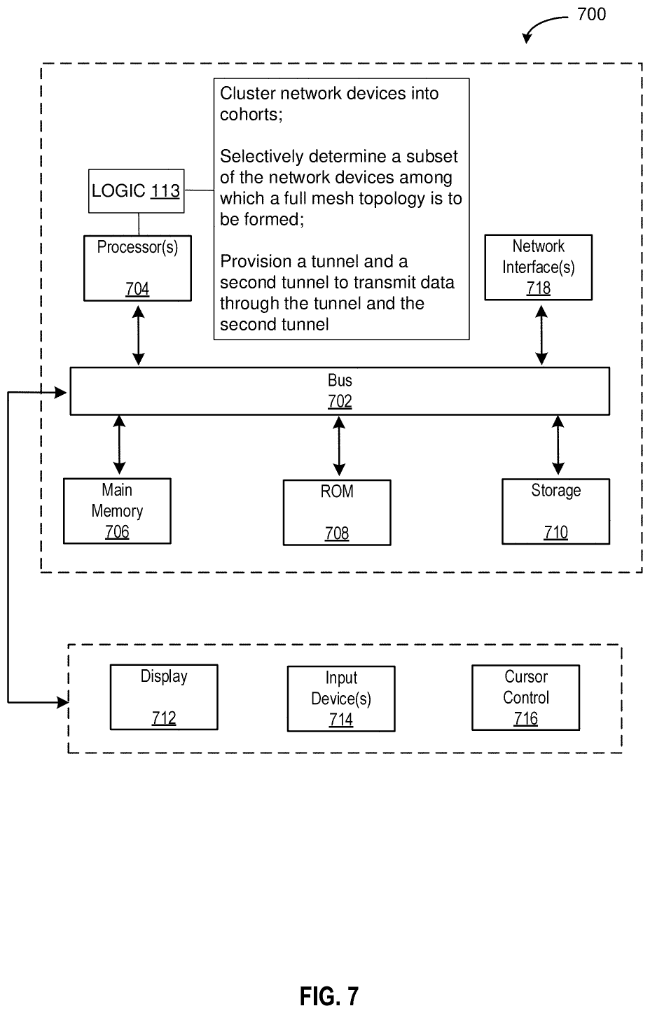

FIG. 5 illustrates a computing component 500 that includes one or more hardware processors 502 and machine-readable storage media 504 storing a set of machine-readable/machine-executable instructions that, when executed, cause the hardware processor(s) 502 to perform an illustrative method of reducing computing costs while maintaining network services and performance. It should be appreciated that there can be additional, fewer, or alternative steps performed in similar or alternative orders, or in parallel, within the scope of the various examples discussed herein unless otherwise stated. In some examples, steps 506-510 may serve as or form part of logic 113 of the computing component 111. The computing component 500 may be implemented as the computing component 111 of FIGS. 1A, 1B, 2, 3A-3D, and 4A-4D. The computing component 400 may include a server. The machine-readable storage media 504 may include suitable machine-readable storage media described in FIG. 7. FIG. 5 summarizes and further elaborates on some aspects previously described.

At step 506, the hardware processor(s) 502 may execute machine-readable/machine-executable instructions stored in the machine-readable storage media 504 to cluster network devices into cohorts. Each cohort of the cohorts includes a logical demarcation of a subset of the network devices. For example, a first cohort may include a first set of the network devices and a second cohort comprises a second set of the network devices. As illustrated in FIGS. 2 and 4A, the determination of the number of cohorts may include determining a number and a distribution of cohorts based on a total number of network devices, such that a minimum number of tunnels is formed. The determination may be according to constraints or restrictions that the network devices in each of the cohorts be fully meshed with one another and that a single network device (e.g., a leader) in each of the cohorts be fully meshed with a single network device from each of the other cohorts. In particular, in a scenario with 16 network devices, five cohorts in which four cohorts have three network devices each and one cohort has four network devices may be implemented.

The clustering may be based on any of the aforementioned criteria described with respect to FIG. 2, including, respective locations of the network devices, software stack embedding that would result from the clustering, bandwidth consumed by different categories of applications, traffic distributions and patterns, a number of different device types connected to each of the network devices, and a reputation of a branch or of each of the network devices.

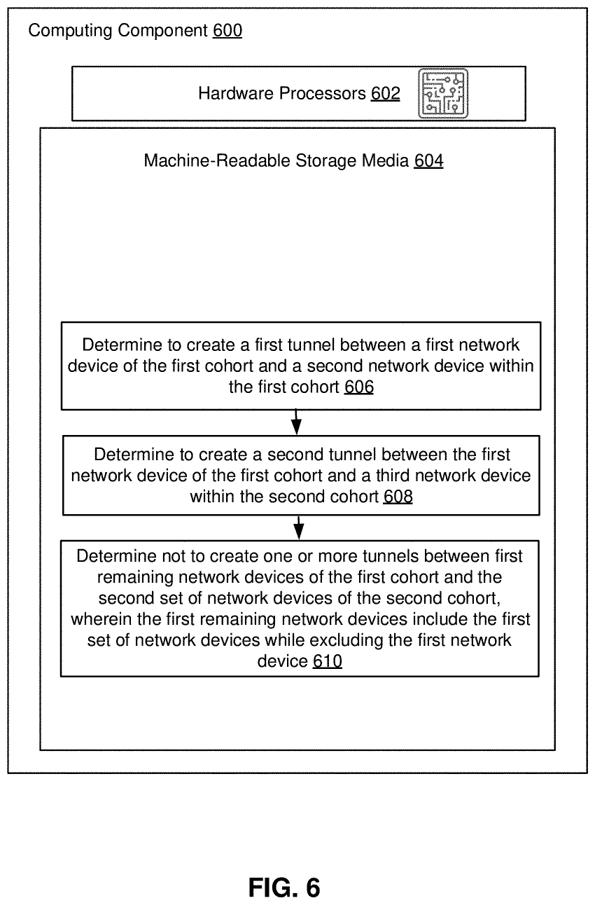

At step 508, the hardware processor(s) 502 may execute machine-readable/machine-executable instructions stored in the machine-readable storage media 504 to selectively determine a subset of the network devices among which a full mesh topology is to be formed or created. In some examples, at least a portion of the determined subset of the network devices may include leaders of cohorts which are responsible for data transmission across different cohorts. In some examples, additionally or alternatively, a portion of the determined subset may be all network devices in a common cohort. In the scenario of the determination of leaders, the determination may be based at least in part on any of, amounts of available bandwidth, available memory, available CPU cycles, jitter, latency, packet loss, and average round trip time within the network devices, models of the network devices, and/or software versions of the network devices, as illustrated with reference to FIGS. 3A and 3B. The selective determination step will be further elucidated in FIG. 6.

At step 510, the hardware processor(s) 502 may execute machine-readable/machine-executable instructions stored in the machine-readable storage media 504 to provision a first tunnel and a second tunnel, which were selectively determined in step 508. The provisioning of the first tunnel and the second tunnel may include, initiating, commencing, facilitating, and/or coordinating a creation of the first tunnel. The provisioning may entail generating unique keys corresponding to each of the first tunnel and the second tunnel. In particular, a first key pair may be generated to initiate creation of the first tunnel. The first key pair may be transmitted to a first device and a second device through which the first tunnel is to be created or formed. Once the first device and the second device use the key pair to successfully transmit data, the first tunnel is created. Similarly, a second key pair may be generated to initiate creation of the second tunnel. The second key pair may be transmitted to the first device and a third device through which the second tunnel is to be created or formed. Once the first device and the third device use the key pair to successfully transmit data, the second tunnel is created.

FIG. 6 illustrates a computing component 600 that includes one or more hardware processors 602 and machine-readable storage media 604 storing a set of machine-readable/machine-executable instructions that, when executed, cause the hardware processor(s) 602 to perform an illustrative method of reducing computing costs while maintaining network services and performance. It should be appreciated that there can be additional, fewer, or alternative steps performed in similar or alternative orders, or in parallel, within the scope of the various examples discussed herein unless otherwise stated. In some examples, steps 606-610 may serve as or form part of logic 113 of the computing component 111. The computing component 600 may be implemented as the computing component 111 of FIGS. 1A, 1B, 2, 3A-3D, and 4A-4D. The computing component 600 may include a server. The machine-readable storage media 604 may include suitable machine-readable storage media described in FIG. 7. FIG. 6 summarizes and further elaborates on some aspects previously described, in particular, of step 508 of FIG. 6.

At step 606, the hardware processor(s) 602 may execute machine-readable/machine-executable instructions stored in the machine-readable storage media 604 to determine that a first tunnel between a first network device of the first cohort and a second network device within the first cohort is to be created. For example, the hardware processors 602 may create tunnels among all network devices within the first cohort such that the network devices within the first cohort are connected in a full mesh topology. In such a manner, the network devices within the first cohort may communicate efficiently while having options of redundant data transmission pathways. Each network device in the first cohort may receive updates regarding statuses of tunnels and/or other network devices, either via periodic DPD signals or from the computing component 600. Therefore, in an event of a failure in either or both a network device or a tunnel, each network device in the first cohort may modify or revise its routing table to determine alternate data transmission paths, such as those that consume a least amount of computing cost.

In some examples, the first network device has a higher historical performance metric or a higher predicted performance metric compared to that of the second network device, based on a comparison of any of amounts of available memory, jitter, latency, packet loss, and average round trip time.

At step 608, the hardware processor(s) 602 may execute machine-readable/machine-executable instructions stored in the machine-readable storage media 604 to determine that a second tunnel between the first network device of the first cohort and a third network device within the second cohort is to be created. For example, the hardware processor(s) 602 may determine that the first network device is a leader of the first cohort and the third network device is a leader of the second cohort. The hardware processor(s) 602 may determine a single leader in each cohort, and determine that tunnels are to connect each of the leaders in a fully meshed topology. In such a manner, data transmission across cohorts may be facilitated.

At step 610, the hardware processor(s) 602 may execute machine-readable/machine-executable instructions stored in the machine-readable storage media 604 to determine not to create, refrain from creating, or skip the creation of, one or more tunnels between first remaining network devices of the first cohort and the second set of network devices of the second cohort. The first remaining network devices may include the first set of network devices besides the first network device. In some examples, the hardware processor(s) 602 may determine not to create a third tunnel between the second network device and the third network device. In some examples, the hardware processor(s) 602 may determine not to create any tunnels between the first remaining network devices and the second set of network devices. For example, only a single network device from the first cohort may be tunneled to only a single network device from the second cohort. On a broader scale, only a single network device from each cohort may be tunneled to only a single network device from each of the other cohorts, as illustrated in FIGS. 2, 3A-3D, and 4A-4D. For example, the hardware processor(s) 602 may determine not to create one or more tunnels between the first network device and the second set of network devices, excluding the third device, within the second cohort. As another example, the hardware processor(s) 602 may determine not to create one or more second tunnels between the first network device of the first cohort, and second remaining network devices of the second cohort, wherein the second remaining network devices comprise the second set of network devices while excluding the third network device.

In such a manner, selectively determining not to create tunnels between devices of different cohorts, except for a single device in each cohort, may reduce computing costs by 77% compared to a full mesh topology across an entire network, without compromising the integrity, speed, or effectiveness of data transmission.

FIG. 7 depicts a block diagram of an example computer system 700 in which various of the examples described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors. In some examples, the hardware processor(s) 704 may implement the logic 113 of the computing component 111, as illustrated in any of FIGS. 1A, 1B, 2, 3A, 3B, 3C, 3D, 4A, 4B, 4C, 4D, 5, and 6.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by the hardware processor(s) 704. Such instructions, when stored in storage media accessible to the hardware processor(s) 704, render computer system 700 into a special-purpose machine that is customized to perform the operations specified in the instructions.

The computer system 700 further includes a read only memory (ROM) 708 or other static storage device coupled to bus 702 for storing static information and instructions for the hardware processor(s) 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to the hardware processor(s) 704. Another type of user input device is cursor control 716, such as a mouse, a trackball, or cursor direction keys for communicating direction information and command selections to the hardware processor(s) 704 and for controlling cursor movement on display 712. In some examples, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “component,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one example, the techniques herein are performed by computer system 700 in response to the hardware processor(s)704 executing one or more sequences of one or more instructions contained in main memory 706. Such instructions may be read into main memory 706 from another storage medium, such as storage device 710. Execution of the sequences of instructions contained in main memory 706 causes the hardware processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by the hardware processor(s) 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

What is claimed is:

1. A computer-implemented method, comprising:
clustering network devices into a plurality of cohorts, wherein a first cohort comprises a first set of the network devices and a second cohort comprises a second set of the network devices;
selectively determine a subset of the network devices among which a full mesh topology is to be formed, based on any of parameters, wherein the parameters are selected from:
amounts of available bandwidth, available memory, available CPU cycles, jitter, latency, packet loss, and average round trip time within the network devices, the selective determination comprising:
determining to create a first tunnel between a first network device of the first cohort and a second network device within the first cohort;
determining to create a second tunnel between the first network device of the first cohort and a third network device within the second cohort; and
determining not to create one or more tunnels between first remaining network devices of the first cohort and the second set of network devices of the second cohort, wherein the first remaining network devices comprise the first set of network devices while excluding the first network device; and
provisioning the tunnel and the second tunnel to transmit data through the tunnel and the second tunnel.

2. The computer-implemented method of claim 1, wherein the clustering is based on any of respective locations of the network devices, software stack embedding that would result from the clustering, bandwidth consumed by different categories of applications on the network devices, traffic distributions and patterns of the network devices, a number of different device types connected to each of the network devices, and a reputation of each of the network devices.

3. The computer-implemented method of claim 1, further comprising:
determining not to create one or more tunnels between the first network device and the second set of network devices, excluding the third device, within the second cohort.

4. The computer-implemented method of claim 1, wherein the clustering of the network devices comprises determining a distribution of the cohorts.

5. The computer-implemented method of claim 1, wherein the selective determination further comprises determining not to create one or more second tunnels between the first network device of the first cohort, and second remaining network devices of the second cohort, wherein the second remaining network devices comprise the second set of network devices while excluding the third network device.

6. The computer-implemented method of claim 1, wherein the selective determination further comprises creating only a single tunnel between the first network device of the first cohort and a single network device from each of other cohorts besides the first cohort.

7. The computer-implemented method of claim 1, further comprising creating only a single tunnel between two distinct cohorts.

8. The computer-implemented method of claim 7, wherein the clustering comprises determining a number of cohorts such that each network device is assigned to a cohort and a least total number of tunnels is created, under a condition that tunnels among devices of a common cohort are created and only a single tunnel between two distinct cohorts is created.

9. The computer-implemented method of claim 1, further comprising:
computing a connectivity graph based on current tunnel statuses between the network devices; and
propagating the connectivity graph among the network devices.

10. The computer-implemented method of claim 9, wherein the connectivity graph comprises computing costs of transmitting data packets between two network devices.

11. The computer-implemented method of claim 1, further comprising:
determining the first network device to be a leader within the first cohort, based on a predicted future performance of the first network device within the first cohort relative to the first remaining network devices within the first cohort;
provisioning the first network device to receive updated statuses regarding tunnels between the network devices;
receiving an indication from one of the first remaining network devices regarding the updated statuses;
in response to receiving the indication, transmitting the updated statuses to the first network device.

12. The computer-implemented method of claim 11, further comprising selectively switching out the first network device as the leader and appointing one of the first remaining network devices as the leader based on a performance attribute of the first network device.

13. A computing system comprising:
one or more processors; and
a memory storing instructions that, when executed by the one or more processors, cause the one or more processors to:
cluster network devices into a plurality of cohorts, wherein a first cohort comprises a first set of the network devices and a second cohort comprises a second set of the network devices;
selectively determine a subset of the network devices among which a full mesh topology is to be formed, based on any of parameters, wherein the parameters are selected from:
amounts of available bandwidth, available memory, available CPU cycles, jitter, latency, packet loss, and average round trip time within the network devices, the selective determination comprising:
determining to create a first tunnel between a first network device of the first cohort and a second network device within the first cohort, wherein the first network device has a higher historical performance metric or a higher predicted performance metric compared to that of the second tunnel, based on a comparison of any of the parameters between the first network device and the second network device;
determining to create a second tunnel between the first network device of the first cohort and a third network device within the second cohort; and
determining to avoid creating a third tunnel between the second network device and the third network device; and
provisioning the tunnel and the second tunnel to transmit data through the tunnel and the second tunnel.

14. The computing system of claim 13, wherein the clustering is based on any of respective locations of the network devices, software stack embedding that would result from the clustering, bandwidth consumed by different categories of applications on the network devices, traffic distributions and patterns of the network devices, a number of different device types connected to each of the network devices, and a reputation of each of the network devices.

15. The computing system of claim 13, wherein the instructions that, when executed by the one or more processors, cause the one or more processors to:
determine not to create one or more tunnels between the first network device and the second set of network devices, excluding the third device, within the second cohort.

16. The computing system of claim 13, wherein the selective determination further comprises determining not to create one or more second tunnels between the first network device of the first cohort, and second remaining network devices of the second cohort, wherein the second remaining network devices comprise the second set of network devices while excluding the third network device.

17. The computing system of claim 13, wherein the selective determination further comprises creating only a single tunnel between the network device of the first cohort and a single network device from each of other cohorts besides the first cohort.

18. The computing system of claim 13, wherein the clustering comprises determining a number of cohorts such that each network device is assigned to a cohort and a least total number of tunnels is created, under a condition that tunnels among devices of a common cohort are created and only a single tunnel between two distinct cohorts is created.

19. The computing system of claim 13, wherein the instructions that, when executed by the one or more processors, cause the one or more processors to:
determine the first network device to be a leader within the first cohort;
provision the first network device to receive updated statuses regarding tunnels between the network devices;
receive an indication from the second network devices regarding the updated statuses; and
in response to receiving the indication, transmit, by the one or more processors, the updated statuses to the first network device.

20. A non-transitory storage medium storing instructions that, when executed by at least one processor of a computing system, cause the computing system to perform a method comprising:
clustering network devices into a plurality of cohorts, wherein a first cohort comprises a first set of the network devices and a second cohort comprises a second set of the network devices, the clustering being based on any of respective locations of the network devices, software stack embedding that would result from the clustering, bandwidth consumed by different categories of applications on the network devices, traffic distributions and patterns of the network devices, a number of different device types connected to each of the network devices, and a reputation of each of the network devices;
selectively determining a subset of the network devices among which a full mesh topology is to be formed, based on any of parameters, wherein the parameters are selected from:
amounts of available bandwidth, available memory, available CPU cycles, jitter, latency, packet loss, and average round trip time within the network devices, the selective determination comprising:
determining to create a first tunnel between a first network device of the first cohort and a second network device within the first cohort, wherein the first network device has a higher historical performance metric or a higher predicted performance metric compared to that of the second tunnel, based on a comparison of any of the parameters between the first network device and the second network device;
determining to create a second tunnel between the first network device of the first cohort and a third network device within the second cohort; and
determining to avoid creating a third tunnel between the second network device and the third network device; and
provisioning the tunnel and the second tunnel to transmit data through the tunnel and the second tunnel.
